(19) United States
(12) Patent Application Publication
(10) Pub. No.: US 2017/0301924 A1
(43) Pub. Date: Oct. 19, 2017

(54) POSITIVE ELECTRODE CATALYST FOR LITHIUM-AIR SECONDARY BATTERY, METHOD FOR MANUFACTURING SAME, AND LITHIUM-AIR SECONDARY BATTERY COMPRISING SAME

(71) Applicant: DONGGUK UNIVERSITY INDUSTRY-ACADEMIC COOPERATION FOUNDATION, Seoul (KR)

(72) Inventors: Yong Mook KANG, Seoul (KR); Seung Ho KANG, Iksan (KR); Kyeong Se SONG, Seoul (KR)

(21) Appl. No.: 15/509,957

(22) PCT Filed: Oct. 15, 2015
(86) PCT No.: PCT/KR2015/010916

§ 371 Date: Mar. 9, 2017

(30) Foreign Application Priority Data
Oct. 15, 2014 (KR) 10-2014-0139273

(51) Int. Cl. H01M 4/90; H01M 4/38; H01M 12/08

(52) U.S. Cl. CPC H01M 4/9016; H01M 12/08; H01M 4/382; H01M 2300/0028

(57) ABSTRACT

The present invention relates to a cathode catalyst for a lithium-air rechargeable battery, a manufacturing method thereof, and a lithium-air rechargeable battery including the same. According to an exemplary embodiment of the present invention, there is provided a manufacturing method of a cathode catalyst for a lithium-air rechargeable battery, including: forming a first solution by adding a titanium ion precursor to a solvent, followed by stirring; forming a second solution by adding an organic material to a solvent, followed by stirring; forming a nanofiber composite by mixing the first and second solutions and spinning the mixed solution; and forming a titanium oxide (TiO₂) nanofiber by performing a heat treatment on the nanofiber composite

### TECHNICAL FIELD

An exemplary embodiment of the present invention relates to a cathode catalyst for a lithium-air rechargeable battery, a manufacturing method thereof, and a lithium-air rechargeable battery including the same.

### BACKGROUND ART

Recently, as resource problems and environmental problems such as depletion of fossil fuels and global warming, etc., are emerging, there is growing interest in renewable energy. In particular, since energy storage devices having a large size, a high power, high energy density are required throughout the industry such as electric vehicles (EVs), hybrid electric vehicles (HEVs), portable power storage devices, and distributed power supply devices, development of a battery is a major issue in the industry.

Due to high energy density of about 75 to 160 Wh/kg and long life characteristic, a lithium ion battery becomes a protagonist of rechargeable batteries, overpowering a nickel-cadmium battery and a nickel-hydrogen battery that were developed earlier. The lithium ion battery has been actively researched to achieve greater capacity and output according to demands of the modern society, and the lithium ion battery having an energy density of up to 250 Wh/kg is expected to be developed in the future. However, the electric vehicle requires the energy storage device having a high energy density of 700 Wh/kg or more, and thus, a new battery system is required to appear.

Among newly proposed various battery systems, a lithium-air rechargeable battery is a system capable of having high power in which a theoretical capacity is 10 times equal to or higher than that of a lithium ion rechargeable battery, and having an environment-friendly characteristic using oxygen that exists infinitely in nature as an active material.

However, the lithium-air rechargeable battery has problems in that a voltage required for charging is higher than a voltage the battery discharges, and thus, a round-trip efficiency is remarkably low, and it is difficult to secure life characteristics and reliability. To solve these problems, it is important to improve the round-trip efficiency by reducing overvoltage during an oxygen reduction reaction and an oxygen evaporation reaction using a catalyst on a cathode.

Therefore, development of the catalyst in the lithium-air rechargeable battery is an important factor, and development of the catalyst suitable for the lithium-air rechargeable battery is in the early stage, and thus, intense research thereof is needed.

### DISCLOSURE

### Technical Problem

The present invention has been made in an effort to provide a cathode catalyst for a lithium-air rechargeable battery, a manufacturing method thereof, and a lithium-air rechargeable battery including the same having advantages of improving an oxygen reduction reaction and an oxygen evaporation reaction of the lithium-air battery.

### Technical Solution

An exemplary embodiment of the present invention provides a manufacturing method of a cathode catalyst for a lithium-air rechargeable battery, including: forming a first solution by adding a titanium ion precursor to a solvent, followed by stirring; forming a second solution by adding an organic material to a solvent, followed by stirring; forming a nanofiber composite by mixing the first and second solutions and spinning the mixed solution; and forming a titanium oxide (TiO₂) nanofiber by performing a heat treatment on the nanofiber composite.

The forming of the first solution by adding a titanium ion precursor to a solvent, followed by stirring, may be performed at room temperature for 0.5 to 2 hours.

The titanium ion precursor may include one or two or more selected from the group consisting of titanium isopropoxide, titanium butoxide, titanium chloride, titanium nitride, and titanium carbide.

The manufacturing method may further include adding 20 to 30 mol % of acetic acid to the first solution when the titanium ion precursor is titanium isopropoxide.

The solvent may include an alcohol-based solvent.

The forming of the second solution by adding an organic material to a solvent, followed by stirring, may be performed at room temperature for 0.5 to 2 hours.

The organic material may include one or two or more selected from the group consisting of polyvinyl pyrrolidone, polymethyl methacrylate, and polystyrene.

The solvent may include an alcohol-based solvent, acetone, distilled water (H₂O), or a combination thereof.

A molar ratio of the organic material to the solvent may be 0.05 to 0.08. In the forming of the nanofiber composite by mixing the first and second solutions and spinning the mixed solution, the mixing may be performed so that a molar ratio of the organic material to the titanium ion precursor is 0.2 to 0.5. The spinning may be performed by electrospinning.

The forming of the titanium oxide (TiO₂) nanofiber by performing a heat treatment on the nanofiber composite, may be performed in an oxidizing atmosphere, and at 400 to 800 for 1 to 7 hours.

The titanium oxide (TiO₂) nanofiber may have one-dimensional structure.

The nanofiber having one-dimensional structure may be an anatase TiO₂ nanofiber, a rutile TiO₂ nanofiber, or a combination thereof.

The anatase titanium oxide nanofiber may be manufactured by calcining the nanofiber composite at 400 to 500 for 1 to 2 hours.

The rutile titanium oxide nanofiber may be manufactured by calcining the nanofiber composite at 750 to 800 for 5 to 7 hours.

Another exemplary embodiment of the present invention provides a cathode catalyst for a lithium-air rechargeable battery manufactured by the manufacturing method of a cathode catalyst for a lithium-air rechargeable battery as described above.

Yet another exemplary embodiment of the present invention provides a lithium-air rechargeable battery including: a cathode for a lithium-air rechargeable battery including the cathode catalyst for a lithium-air rechargeable battery as described above; an anode; an electrolyte; and a separator.

### Advantageous Effects

According to an exemplary embodiment of the present invention, there are provided a cathode catalyst for a lithium-air rechargeable battery, a manufacturing method thereof, and a lithium-air rechargeable battery including the same having excellent electrochemical characteristics by manufacturing titanium oxide (TiO₂) into one-dimensional nanofiber, thereby improving an oxygen reduction reaction and an evaporation reaction.

### DESCRIPTION OF THE DRAWINGS

FIG. 1 shows X-ray diffraction analysis results of an anatase titanium oxide nanofiber and a rutile titanium oxide nanofiber according to an exemplary embodiment.

FIG. 2 shows a scanning electron microscopic analysis result of the anatase titanium oxide nanofiber according to an exemplary embodiment.

FIG. 3 shows a scanning electron microscopic (SEM) analysis result of the rutile titanium oxide nanofiber according to an exemplary embodiment.

FIG. 4 shows a transmission electron microscopic analysis result of the anatase titanium oxide nanofiber according to an exemplary embodiment.

FIG. 5 shows a transmission electron microscopic analysis result of the rutile titanium oxide nanofiber according to an exemplary embodiment.

FIG. 6 shows an initial capacity of a lithium-air battery according to another exemplary embodiment.

FIG. 7 shows a differential curve of an initial cycle of the lithium-air battery charged and discharged with 200 mA/g (carbon), according to another exemplary embodiment.

FIG. 8 shows a capacity-limited lifetime characteristic based on a carbon weight specific capacity of 1000 mAh/g (carbon) of the lithium-air battery according to another exemplary embodiment.

FIG. 9 shows a Nyquist characteristic of the lithium-air battery according to another exemplary embodiment.

### BEST MODE FOR INVENTION

Hereinafter, exemplary embodiments of the present invention will be described in detail. However, the following exemplary embodiments are only provided as one embodiment of the present invention, and the present invention is not limited to the following Examples.

In addition, unless explicitly described to the contrary, the word “comprise” and variations such as “comprises” or “comprising”, will be understood to imply the inclusion of stated elements but not the exclusion of any other elements.

The present invention relates to a cathode catalyst for a lithium-air rechargeable battery, a manufacturing method thereof, and a manufacturing method of a lithium-air rechargeable battery including the same, capable of improving an oxygen reduction reaction and an oxygen evaporation reaction of the lithium-air battery.

An exemplary embodiment of the present invention provides the manufacturing method of a cathode catalyst for a lithium-air rechargeable battery, including: forming a first solution by adding a titanium ion precursor to a solvent, followed by stirring; forming a second solution by adding an organic material to a solvent, followed by stirring; forming a nanofiber composite by mixing the first and second solutions and spinning the mixed solution; and forming a titanium oxide (TiO₂) nanofiber by performing a heat treatment on the nanofiber composite.

More specifically, in an exemplary embodiment of the present invention, the forming of the first solution by adding a titanium ion precursor to a solvent, followed by stirring, may be performed at room temperature for 0.5 to 2 hours, and preferably, 1 to 1.5 hours. Here, when the stirring is performed for less than 0.5 hours, the titanium ion precursor may not be sufficiently dissolved in the solvent, and when the stirring is performed for more than 2 hours, titanium may be precipitated.

Here, the titanium ion precursor may include one or two or more selected from the group consisting of titanium isopropoxide, titanium butoxide, titanium chloride, titanium nitride, and titanium carbide.

Further, the solvent may include an alcohol-based solvent. The alcohol-based solvent may be, for example, ethanol.

Here, when the titanium ion precursor is titanium isopropoxide, acetic acid may be added to the first solution in an amount of 20 to 30 mol % to prevent the precipitation of the titanium isopropoxide during the formation of the first solution.

In an exemplary embodiment of the present invention, the forming of the second solution by adding an organic material to a solvent, followed by stirring, may be performed at room temperature for 0.5 to 2 hours, and preferably, 1 to 1.5 hours, which is the same as described in the formation of the first solution. Here, when the stirring is performed for less than 0.5 hours, the organic material may not be sufficiently dissolved in the solvent. When the stirring is performed for more than 2 hours, a viscosity of the second solvent may be out of the range.

Here, the organic material may include one or two or more selected from the group consisting of polyvinyl pyrrolidone, polymethyl methacrylate, and polystyrene.

Further, the solvent may include an alcohol-based solvent, acetone, distilled water (H₂O), or a combination thereof. The alcohol-based solvent may be, for example, methanol, propanol, butanol, isopropyl alcohol (IPA), and the like.

Here, a molar ratio of the organic material to the solvent may be 0.05 to 0.08, and preferably, 0.06. When the molar ratio of the organic material to the solvent is less than 0.05, beads may be formed. When the molar ratio is more than 0.08, a thickness of the titanium oxide (TiO₂) nanofiber described later may be excessively thickened.

In an exemplary embodiment of the present invention, in the forming of the nanofiber composite by mixing the first and second solutions and spinning the mixed solution, the first solution and the second solution formed in the above-described process may be mixed at a predetermined ratio, and then, the nanofiber composite may be formed by controlling the spinning process.

Here, regarding the predetermined ratio, a molar ratio of the organic material in the second solution to the titanium ion precursor in the first solution is preferably 0.2 to 0.5. When the molar ratio of the organic material to the titanium ion precursor is less than 0.2, the titanium oxide (TiO₂) nanofiber may not be formed or the nanofiber may be formed to have a very short length. When the molar ratio thereof is more than 0.5, the thickness of the titanium oxide (TiO₂) nanofiber may be excessively thickened.

Here, the spinning process may be performed by electrospinning.

The electrospinning may be performed by using an electrospinning device including a feeder for feeding a solution, a spinning nozzle for spinning a solution supplied through the feeder, a collector for collecting a fiber spinned through the spinning nozzle, and a voltage generator for applying a voltage between the spinning nozzle and the collector, wherein organic/inorganic solution may be supplied to the feeder, and a voltage may be applied thereto, thereby manufacturing a fiber form. This is advantageous in that a fibrous material is able to be relatively and easily synthesized as compared to conventional bottom-up methods such as CVD and PVD, etc., and other top-down techniques.

Control conditions for the electrospinning process may include a speed at which the mixed solution is pushed, a rated voltage, a distance between a needle and an aluminum foil to be collected, and a thickness of the needle, etc. For example, the speed at which the mixed solution is pushed is preferably 0.4 to 0.6 ml/h, the voltage is preferably 14.5 to 15.5 kV, the distance between the needle and the aluminum foil is preferably 8 to 10 cm, and the thickness of the needle is preferably 23 to 25 gauge.

In an exemplary embodiment of the present invention, the forming of the titanium oxide (TiO₂) nanofiber by performing a heat treatment on the nanofiber composite, may be performed in an oxidizing atmosphere in air, and at 400 to 800 for 1 to 7 hours. Here, when a temperature for the heat treatment is less than 400, the organic material may not be sufficiently removed. When the temperature is more than 700, a structure of the titanium oxide (TiO₂) nanofiber may not be maintained. In addition, when a time for the heat treatment is less than 1 hour, the organic material may not be sufficiently removed. When the time is more than 7 hours, a structure of the titanium oxide (TiO₂) nanofiber may not be maintained.

More specifically, the titanium oxide (TiO₂) nanofiber formed by an exemplary embodiment of the present invention may have one-dimensional structure, and may include an anatase TiO₂ nanofiber, a rutile TiO₂ nanofiber, or a combination thereof.

Here, the anatase titanium oxide nanofiber may be formed by calcining the nanofiber composite at 400 to 500 for 1 to 2 hours, and the rutile titanium oxide nanofiber may be formed by calcining the nanofiber composite at 750 to 800 at 5 to 7 hours. In addition, when the nanofiber composite is calcined at a temperature of more than 500 to less than 750 for more than 1 hour to less than 5 hours, a titanium oxide nanofiber mixed with an anatase phase and a rutile phase is formed.

### MODE FOR INVENTION

Hereinafter, Examples and Comparative Examples of the present invention will be described. However, the following Examples are only the preferred exemplary embodiments of the present invention, and therefore, the present invention is not limited thereto the following examples.

### Example

### Example 1: Preparation of Titanium Oxide Nanofiber (TiO₂ Nanofiber)

Titanium isopropoxide, which is a titanium precursor, was added to ethanol, and stirred at room temperature for 1 hour, to prepare a first solution. In this process, 25 mol % of acetic acid was added to prevent precipitation of titanium isopropoxide.

On the other hand, polyvinyl pyrrolidone, which is an organic material, was added to ethanol, and stirred at room temperature for 1 hour to prepare a second solution. Here, a concentration of the organic material was adjusted to 5 to 8 mol % based on the solvent.

Then, the first and second solutions were mixed, and stirred to obtain a homogeneous mixed solution. Here, a molar ratio of the organic material to the titanium oxide precursor in the mixed solution was 1/3.

A nanofiber composite was formed by electrospinning with the mixed solution. Here, as conditions for the electrospinning, a speed at which the mixed solution is pushed was 0.5 ml, a voltage was 14.5 to 15.5 kV, a distance between a needle and an aluminum foil to be collected was 9 cm, and a thickness of the needle was 23 gauge.

Here, the nanofiber composite included the organic material/titanium precursor, and was calcined in an oxidizing atmosphere in air, and at 450 for 1 hour, thereby manufacturing an anatase titanium oxide nanofiber (anatase TiO₂ nanofiber) from which the organic material is removed.

On the other hand, the nanofiber composite including the organic material/titanium precursor may be phase-controlled by controlling a calcination temperature and time. For example, a rutile titanium oxide nanofiber (rutile TiO₂ nanofiber) from which the organic material is removed was manufactured by calcination in an oxidizing atmosphere in air, and at 750 for 5 hours. Further, a titanium oxide nanofiber mixed with an anatase phase and a rutile phase was manufactured by calcination at 700 for 4 hours.

### Example 2: Manufacture of Lithium-Air Battery

In a manufacturing method of a lithium-air battery, an electrode for a lithium-air battery was first manufactured by mixing a titanium oxide nanofiber, Ketjen black, and PVDF-HFP at a ratio of 40:45:15 wt % using N-methylpyrrolidone as a solvent. The prepared slurry was applied thinly on a carbon paper, and dried at 120 for 5 hours. After drying, an electrode plate was transferred to a glove box, and a battery was manufactured using.

Swagelok-type cells. Here, lithium metal foils were used as a counter electrode, a glass fiber disk was used as a separator, and an electrolyte was prepared by stirring 1M LiCF₃ SO₃ in tetraethyleneglycol dimethylether. Lastly, the assembled cell was taken out of the glove box, and oxygen gas (99.995%) was added for 10 minutes at 1 sccm. Then, electrochemical characteristics were evaluated.

### Evaluation

### Experimental Example 1: X-Ray Diffraction Analysis

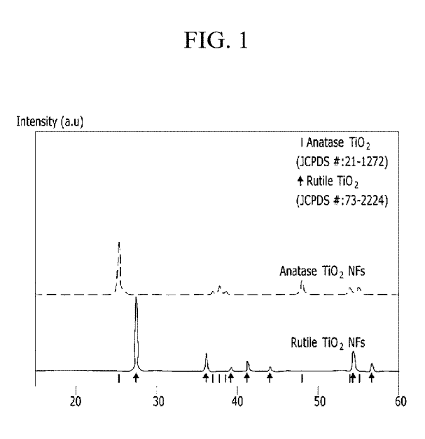

To analyze structures of the anatase titanium oxide nanofiber and the rutile titanium oxide nanofiber of Example 1, X-ray diffraction analysis results were shown in FIG. 1.

Referring to FIG. 1, the anatase titanium oxide had characteristic peaks at two theta (θ) angles of 25.281 degrees (101), 36.946 degrees (103), 37.800 degrees (004), 38.575 degrees (112), 48.049 degrees (200), 53.890 degrees (105), 55.060 degrees (211). In addition, the rutile titanium oxide had characteristic peaks at two theta (θ) angles of 27.444 degrees (110), 36.080 degrees (101), 39.203 degrees (200), 41.242 degrees (111), 44.057 degrees (210), 54.330 degrees (211), 56.644 degrees (220).

### Experimental Example 2: Scanning Electron Microscopic Analysis, Transmission Electron Microscopic Analysis

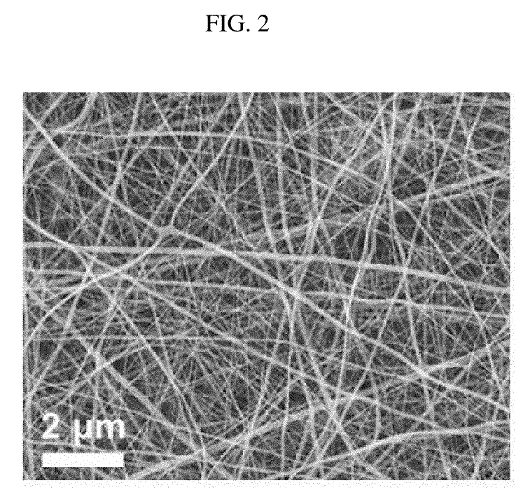

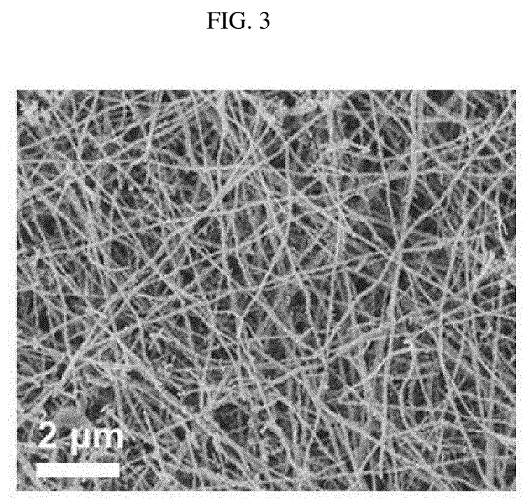

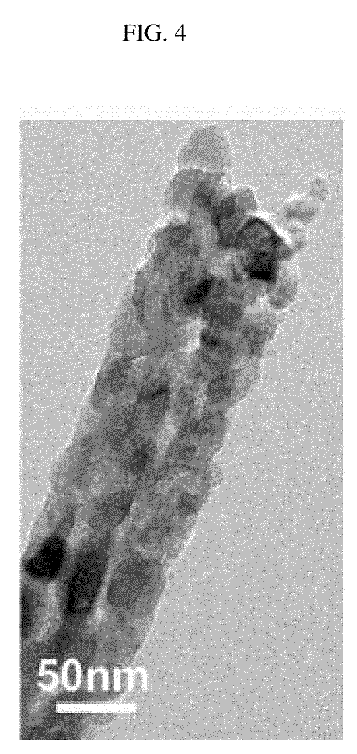

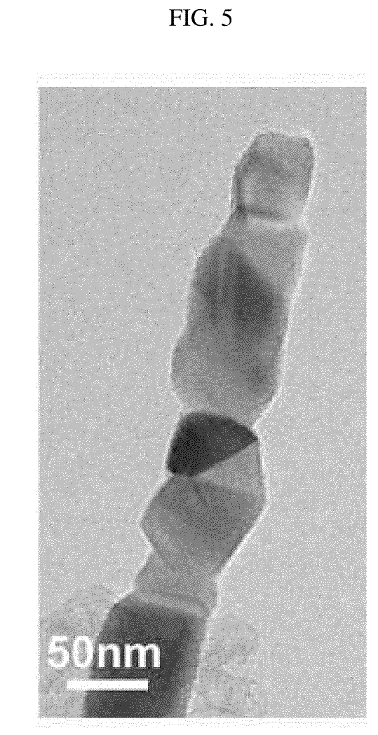

To analyze forms and crystal lattice of the anatase titanium oxide nanofiber and the rutile titanium oxide nanofiber of Example 1, scanning electron microscopic analysis results of the anatase titanium oxide nanofiber and the rutile titanium oxide nanofiber were shown in FIGS. 2 and 3, respectively. Transmission electron microscopic analysis results of the anatase titanium oxide nanofiber and the rutile titanium oxide nanofiber, were shown in FIGS. 4 and 5, respectively.

Referring to FIGS. 2 and 3, forms of each phase, i.e., the anatase titanium oxide nanofiber and the rutile titanium oxide nanofiber were well shown. In addition, referring to FIGS. 4 and 5, it could be appreciated that both of the anatase titanium oxide nanofiber and the rutile titanium oxide nanofiber had one-dimensional form.

In summary, it could be appreciated that the titanium oxide nanofiber in which the anatase phase form and the rutile phase form are well maintained, was manufactured.

### Experimental Example 3: Evaluation of Electrochemical Characteristics

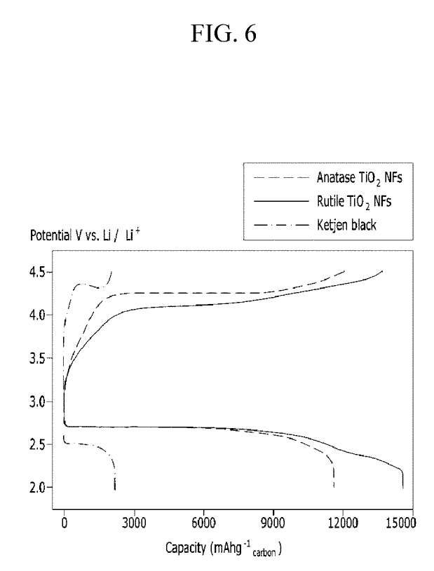

Electrochemical analysis results of catalytic activity of the anatase titanium oxide nanofiber and the rutile titanium oxide nanofiber of Example 1 were shown in FIGS. 6 to 8.

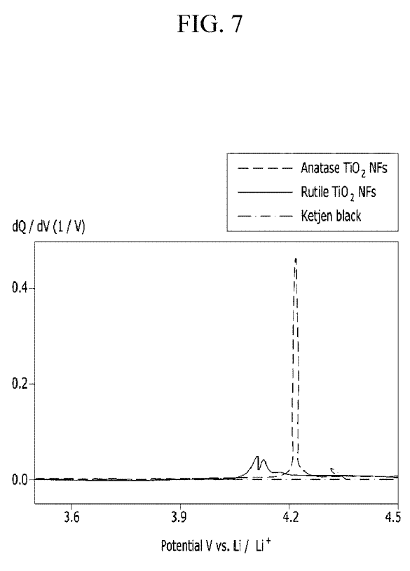

First, the lithium-air battery manufactured by the method of Example 2 using the cathode active material containing the catalyst, was charged and discharged at 2 to 4.5 V with 200 mA/g (carbon), respectively, and measurement results of the charge and discharge characteristics were shown in FIGS. 6 and 7.

Referring to FIG. 6, it was shown that potential flat surfaces in which oxygen and lithium were combined/decomposed at the time of the oxygen reduction reaction and the evaporation reaction were exhibited, and an initial capacity of the rutile titanium oxide nanofiber was increased as compared to that of the anatase titanium oxide nanofiber. As a control group, evaluation results of a battery manufactured without adding the titanium oxide catalyst were also shown.

FIG. 7 shows a differential curve of an initial cycle of the lithium-air battery charged and discharged with 200 mA/g (carbon), respectively, and it could be confirmed that an overvoltage of the lithium-air battery using the rutile phase titanium oxide nanofiber was reduced as compared to the lithium-air battery using the anatase titanium oxide nanofiber.

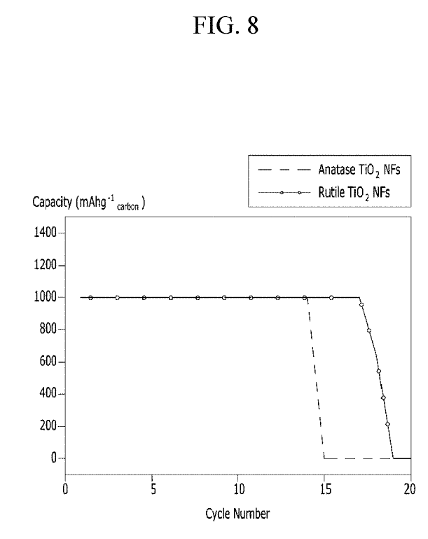

On the other hand, during the charging and the discharging at 2 to 4.5V, a constant voltage was maintained at 4.2V, and the limit was set based on at 200 mA/g (carbon) and carbon weight specific capacity of 1000 mAh/g (carbon), and 20 cycles of charging and discharging were performed. Measurement results of the charging and discharging characteristics were shown in FIG. 8.

FIG. 8 is provided to show a capacity-limited lifetime characteristic based on the carbon weight specific capacity of 1000 mAh/g (carbon), and it could be appreciated that the lifetime of the lithium-air battery using the rutile titanium oxide nanofiber was improved as compared to that of the anatase titanium oxide nanofiber.

### Experimental Example 4: Analysis of Impedance Curve

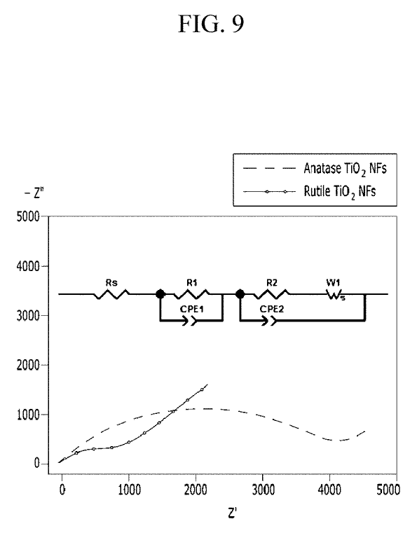

Measurement results of Nyquist characteristic at 0.1 to 100 kHz after the lithium-air battery manufactured by Example 2 was discharged with 200 mA/g (carbon), were shown in FIG. 9.

Referring to FIG. 9, it could be confirmed that when the anatase titanium oxide nanofiber and the rutile titanium oxide nanofiber were operated in the same circuit, the rutile titanium oxide nanofiber had a lower band gap than that of the anatase titanium oxide nanofiber, and thus, a charge transfer resistance was reduced due to improvement of an e-transition. It could be appreciated from the above results that a contact area of oxygen and lithium ions and a diffusion distance of lithium ions were reduced in rutile titanium oxide nanofiber as compared to those of the anatase titanium oxide nanofiber, and thus, electrical conductivity and ion conductivity were greatly improved.

The present invention is not limited to the exemplary embodiments disclosed herein but will be implemented in various forms. Those skilled in the art will appreciate that various modifications and alterations may be made without departing from the technical spirit or essential feature of the present invention. Therefore, the exemplary embodiments described herein are provided by way of example only and should not be construed as being limited.

1. A manufacturing method of a cathode catalyst for a lithium-air rechargeable battery, comprising:
forming a first solution by adding a titanium ion precursor to a solvent, followed by stirring;
forming a second solution by adding an organic material to a solvent, followed by stirring;
forming a nanofiber composite by mixing the first and second solutions and spinning the mixed solution; and
forming a titanium oxide (TiO₂) nanofiber by performing a heat treatment on the nanofiber composite.

2. The manufacturing method of claim 1, wherein:
the forming of the first solution by adding a titanium ion precursor to a solvent, followed by stirring, is performed at room temperature for 0.5 to 2 hours.

3. The manufacturing method of claim 2, wherein:
the titanium ion precursor includes one or two or more selected from the group consisting of titanium isopropoxide, titanium butoxide, titanium chloride, titanium nitride, and titanium carbide.

4. The manufacturing method of claim 3, further comprising:
adding 20 to 30 mol % of acetic acid to the first solution when the titanium ion precursor is titanium isopropoxide.

5. The manufacturing method of claim 2, wherein:
the solvent includes an alcohol-based solvent.

6. The manufacturing method of claim 1, wherein:
the forming of the second solution by adding an organic material to a solvent, followed by stirring, is performed at room temperature for 0.5 to 2 hours.

7. The manufacturing method of claim 6, wherein:
the organic material includes one or two or more selected from the group consisting of polyvinyl pyrrolidone, polymethyl methacrylate, and polystyrene.

8. The manufacturing method of claim 6, wherein:
the solvent includes an alcohol-based solvent, acetone, distilled water (H₂O), or a combination thereof.

9. The manufacturing method of claim 6, wherein:
a molar ratio of the organic material to the solvent is 0.05 to 0.08.

10. The manufacturing method of claim 1, wherein:
in the forming of the nanofiber composite by mixing the first and second solutions and spinning the mixed solution,
the mixing is performed so that a molar ratio of the organic material to the titanium ion precursor is 0.2 to 0.5.

11. The manufacturing method of claim 1, wherein:
the spinning is performed by electrospinning.

12. The manufacturing method of claim 1, wherein:
the forming of the titanium oxide (TiO₂) nanofiber by performing a heat treatment on the nanofiber composite, is performed in an oxidizing atmosphere, and at 400° C. to 800° C. for 1 to 7 hours.

13. The manufacturing method of claim 12, wherein:
the titanium oxide (TiO₂) nanofiber has one-dimensional structure.

14. The manufacturing method of claim 13, wherein:
the nanofiber having one-dimensional structure is an anatase TiO₂ nanofiber, a rutile TiO₂ nanofiber, or a combination thereof.

15. The manufacturing method of claim 14, wherein:
the anatase titanium oxide nanofiber is manufactured by calcining the nanofiber composite at 400° C. to 500° C. for 1 to 2 hours.

16. The manufacturing method of claim 14, wherein:
the rutile titanium oxide nanofiber is manufactured by calcining the nanofiber composite at 750° C. to 800° C. for 5 to 7 hours.

17. A cathode catalyst for a lithium-air rechargeable battery manufactured by the manufacturing method of a cathode catalyst for a lithium-air rechargeable battery of claim 1.

18. A lithium-air rechargeable battery comprising:
a cathode for a lithium-air rechargeable battery including the cathode catalyst for a lithium-air rechargeable battery of claim 17;
an anode;
an electrolyte; and
a separator.
